(19) United States
(12) Patent Application Publication
(10) Pub. No.: US 2026/0342001 A1
(43) Pub. Date: Oct. 29, 2026

(54) ELECTRONIC APPARATUS AND PLUGGABLE MODULE

(71) Applicant: Wistron NeWeb Corp., Hsinchu (TW)

(72) Inventor: BO-YEN CHEN, HSINCHU (TW)

(21) Appl. No.: 19/211,478

(22) Filed: May 19, 2025

(30) Foreign Application Priority Data
Apr. 25, 2025 (TW) 114115636

(51) Int. Cl. H01R 13/516; H01R 24/52

(52) U.S. Cl. CPC H01R 13/516; H01R 24/52

(57) ABSTRACT

An electronic apparatus and a pluggable module. The electronic apparatus includes a slot, a pluggable module receiver, and a pluggable module. The slot includes a first hook located within the slot, and the pluggable module receiver includes a second hook located within the pluggable module receiver. The pluggable module includes a first locking protrusion and a second locking protrusion, wherein the pluggable module is configured to pass through the slot along an insertion direction and be inserted into the pluggable module receiver. The first locking protrusion of the pluggable module is configured to latch with the first hook of the slot, and the second locking protrusion of the pluggable module is configured to latch with the second hook of the pluggable module receiver.

### CROSS-REFERENCE TO RELATED PATENT APPLICATION

This application claims the benefit of priority to Taiwan Patent Application No. 114115636, filed on Apr. 25, 2025. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The disclosure relates to an electronic apparatus and a pluggable module that can be inserted into the electronic apparatus.

### BACKGROUND OF THE DISCLOSURE

In the era of network communication, the requirements for the transmission quality and transmission volume of networks are gradually increasing, and the network transmission interfaces are becoming more complex. To accommodate a wide variety transmission interfaces, electronic apparatuses such as Access Point (AP) apparatuses and routers often use Small Form-Factor pluggable (SFP) modules as input/output connectors. The modular design of SFP modules allows them to be easily inserted into or removed from electronic apparatuses to adapt to different usage scenarios. Furthermore, SFP modules can support various different transmission interfaces such as fiber optics, Ethernet, coaxial cables, etc.

Typically, SFP modules are used in conjunction with SFP module receivers disposed in electronic apparatuses. After the SFP module is inserted into the electronic apparatus, it can be locked with the pluggable module receiver to secure the position of the SFP module. The SFP module can also be unlocked from the SFP module receiver, allowing the user to remove the SFP module from the electronic apparatus.

Recently, specification requirements for electronic apparatuses have become increasingly stringent, requiring features such as better drop resistance and vibration resistance. While the pluggable feature of SFP modules is convenient, it also poses a potential factor for structural instability. For example, electronic apparatuses may experience impact from drops, vibrations, or other reasons that could cause the SFP module to release from the SFP module receiver, making it difficult for the electronic apparatuses to meet requirements on drop resistance and vibration resistance.

Therefore, there is a need for a solution that can enhance the connection stability between the SFP module and the electronic apparatus while at the same time maintaining the pluggable feature of the SFP module.

### SUMMARY OF THE DISCLOSURE

In some embodiments, the present disclosure provides an electronic apparatus that allows a pluggable module to be inserted along an insertion direction. The electronic apparatus includes a panel, a slot, and a pluggable module receiver. The slot has a front opening and a rear opening, and the front opening is formed in the panel. The slot includes a slot housing and a first hook attached to the slot housing, and the slot housing extends between the front opening and the rear opening. The pluggable module receiver has a receiving port and is located within the electronic apparatus. The pluggable module receiver includes a pluggable module housing and a second hook attached to the pluggable module housing. The front opening, rear opening, and receiving port are aligned along the insertion direction for allowing the pluggable module to be inserted. The first hook and second hook are configured to respectively latch onto the pluggable module after the pluggable module is inserted into the electronic apparatus.

In some embodiments, the present disclosure provides a pluggable module that can be inserted into the electronic apparatus. The pluggable module includes a body, a first locking protrusion, a second locking protrusion, and an unlocking plate. The body includes a front body and a rear body, the front body includes a front end of the body, while the rear body includes a rear end of the body. The first locking protrusion is located on the front body, and the second locking protrusion is located on the rear body. At least a portion of the unlocking plate is accommodated within the front body. The first locking protrusion and the second locking protrusion are configured to respectively latch with the electronic apparatus after the pluggable module is inserted into the electronic apparatus. The unlocking plate is configured to shift in a shifting direction from the front end to the rear end to release the latching between the first locking protrusion and the electronic apparatus as well as the latching between the second locking protrusion and the electronic apparatus.

In some embodiments, the present disclosure provides an electronic apparatus that includes a slot, a pluggable module receiver, and a pluggable module. The slot includes a first hook located within the slot. The pluggable module receiver includes a second hook located within the pluggable module receiver. The pluggable module includes a body, a first locking protrusion, and a second locking protrusion. The body includes a front body and a rear body, the front body including a front end of the body, while the rear body including a rear end of the body. The first locking protrusion is located on the front body, and the second locking protrusion is located on the rear body. The pluggable module is configured to pass through the slot and be inserted into the pluggable module receiver along the insertion direction. The first locking protrusion of the pluggable module is configured to latch with the first hook of the slot, and the second locking protrusion of the pluggable module is configured to latch with the second hook of the pluggable module receiver.

These and other aspects of the present disclosure will become apparent from the following description of the embodiment taken in conjunction with the attached drawings and their captions.

### BRIEF DESCRIPTION OF THE DRAWINGS

The described embodiments may be better understood by reference to the following description and the accompanying drawings.

FIG. 1A, FIG. 1B, and FIG. 1C respectively show a separated state, locked state, and unlocked state between the pluggable module and the electronic apparatus according to some embodiments of the present disclosure.

FIG. 2 shows a schematic view of the panel and the slot of the electronic apparatus according to some embodiments of the present disclosure.

FIG. 3 shows a schematic view of the pluggable module according to some embodiments of the present disclosure.

FIG. 4 shows a schematic view of the pluggable module receiver according to some embodiments of the present disclosure.

FIG. 5 shows a schematic view of the pluggable module receiver passing through the slot according to some embodiments of the present disclosure.

FIG. 6A and FIG. 6B show a schematic view of a pull plate of the pluggable module pushing the unlocking plate via pivoting according to some embodiments of the present disclosure.

FIG. 7A and FIG. 7B show a schematic view of the locking between the pluggable module and the electronic apparatus according to some embodiments of the present disclosure.

FIG. 8A and FIG. 8B show a schematic view of the unlocking of the pluggable module and the electronic apparatus according to some embodiments of the present disclosure.

FIG. 9 shows a variation of the pluggable module from FIG. 3.

### DETAILED DESCRIPTION OF THE EXEMPLARY EMBODIMENTS

The techniques of the present disclosure are more particularly described in the following examples that are intended as illustrative only since numerous modifications and variations will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

Those skilled in the art can understand the advantages and effects of the disclosure from the content disclosed in this specification. The disclosure can be implemented or applied through various other specific embodiments, and the details in this specification can be modified and changed based on different perspectives and applications without departing from the concept of the disclosure. Additionally, the drawings of the disclosure are merely simple schematic representations and are not drawn to actual scale, as previously stated. The following embodiments will further detail the relevant technical content of the disclosure, but the disclosed content is not intended to limit the scope of protection of the disclosure. Furthermore, it should be understood that although terms such as “first,” “second,” and “third” may be used in this text to describe various components, these components should not be limited by these terms. These terms are primarily used to distinguish one component from another.

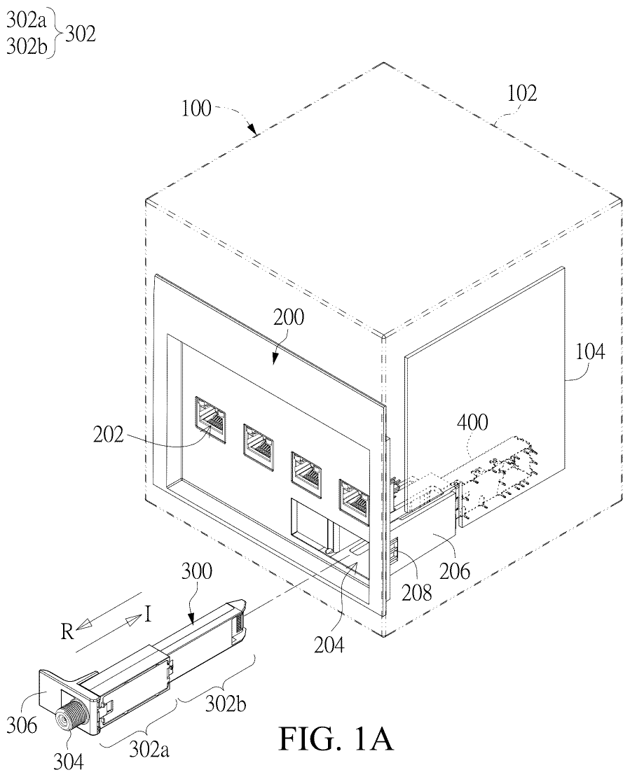

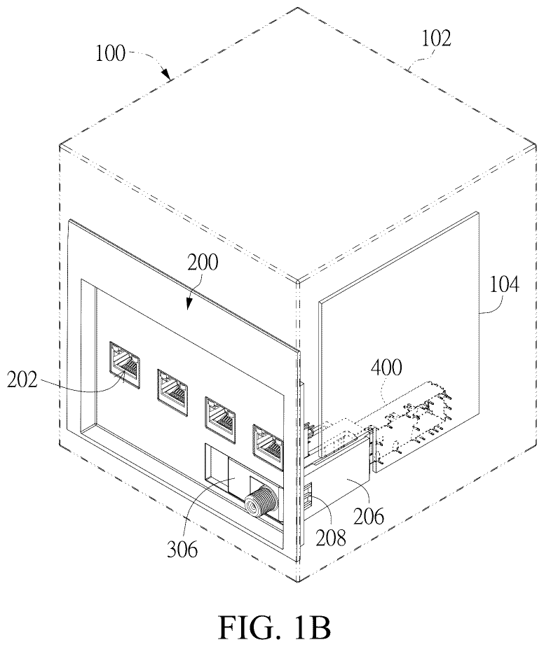

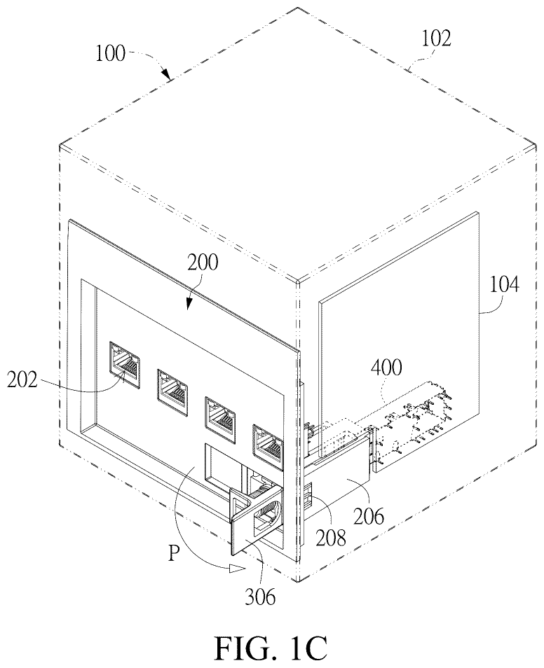

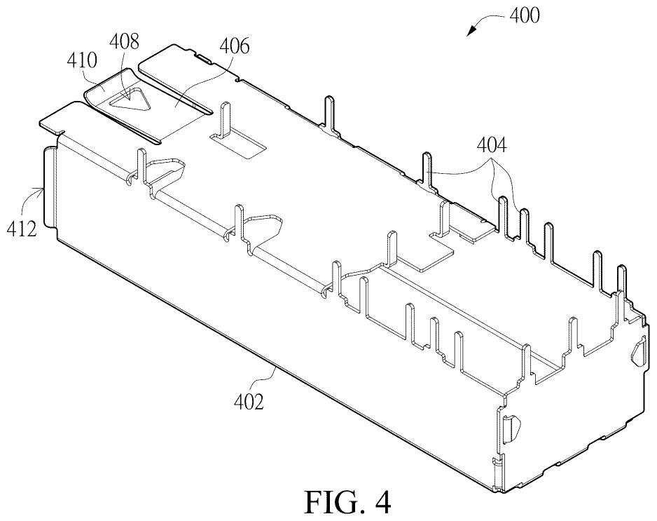

FIG. 1A, FIG. 1B, and FIG. 1C respectively show the separated state, locked state, and unlocked state between the electronic apparatus 100 and the pluggable module 300 according to some embodiments of the disclosure. FIG. 1A, FIG. 1B, and FIG. 1C can be referenced together. The electronic apparatus 100 includes an electronic apparatus housing 102 and a panel 200 mounted on the electronic apparatus housing 102. The panel 200 may have a connector hole 202 and a slot 204. The connector hole 202 can be used to install different types of connectors, which can be either male or female connectors. For example, in some embodiments, a female connector for Ethernet may be disposed in the connector hole 202 to receive an Ethernet plug (not shown). The slot 204 can include a slot housing 206, and the slot housing 206 can be fixed to the panel 200. In some embodiments, the panel 200 and the slot housing 206 can be integrally formed or connected together by welding, adhesive, or other means. The panel 200 and the slot housing 206 can be made of plastic or metal. The pluggable module 300 can be inserted into the slot 204 along the insertion direction I or removed from the slot 204 along the removal direction R that is opposite to the insertion direction I. A circuit board 104 and a pluggable module receiver 400 fixed on the circuit board 104 may be disposed in the electronic apparatus 100. Since the pluggable module receiver 400 is fixed on the circuit board 104, the position of the pluggable module receiver 400 within the electronic apparatus 100 will move along with the circuit board 104. The circuit board 104 can be secured within the electronic apparatus housing 102 of the electronic apparatus 100 using screws or any suitable fasteners, and the position of the circuit board 104 within the electronic apparatus 100 can be arranged to align the pluggable module receiver 400 with the slot 204 in the insertion direction I (or removal direction R), allowing the pluggable module 300 to pass through the slot 204 and be inserted into the pluggable module receiver 400. A first hook 208 is disposed within the slot 204, and a second hook 406 is disposed within the pluggable module receiver 400 (see FIG. 4), so when the pluggable module 300 is inserted into the electronic apparatus 100, the first hook 208 and the second hook 406 can respectively latch onto the pluggable module 300. The pluggable module 300 may include a connector 304, and an adapter (not shown) may be disposed within the pluggable module receiver 400; accordingly, when the pluggable module 300 is inserted into the pluggable module receiver 400, signals can be transmitted from the connector 304 through the pluggable module 300 and then transferred to other electronic components on the circuit board 104. In this embodiment, the connector 304 is a coaxial connector, but the connector 304 may also be other types of male or female connectors.

The pluggable module 300 includes a body 302, and the body 302 further includes a front body 302a and a rear body 302b, wherein the shape of the front body 302a can fit with the shape of the slot housing 206 of the slot 204, and the shape of the rear body 302b can fit with the shape of the pluggable module receiver 400. After the pluggable module 300 passes through the slot 204 and is inserted into the pluggable module receiver 400, the front body 302a can latch with the slot housing 206, and the rear body 302b can latch with the pluggable module receiver 400, allowing the pluggable module 300 to become locked with the electronic apparatus 100 (refer to FIG. 1B). The pluggable module 300 may include a pull plate 306 for user operation. The user can pull the pull plate 306 along a pivoting direction P to pivot the pull plate 306 relative to the pluggable module 300 (particularly the front body 302a of the pluggable module 300), so as to release the locking between the pluggable module 300 and the electronic apparatus 100, thereby allowing the pluggable module 300 to be removed from the electronic apparatus 100 along the removal direction R (refer to FIG. 1C).

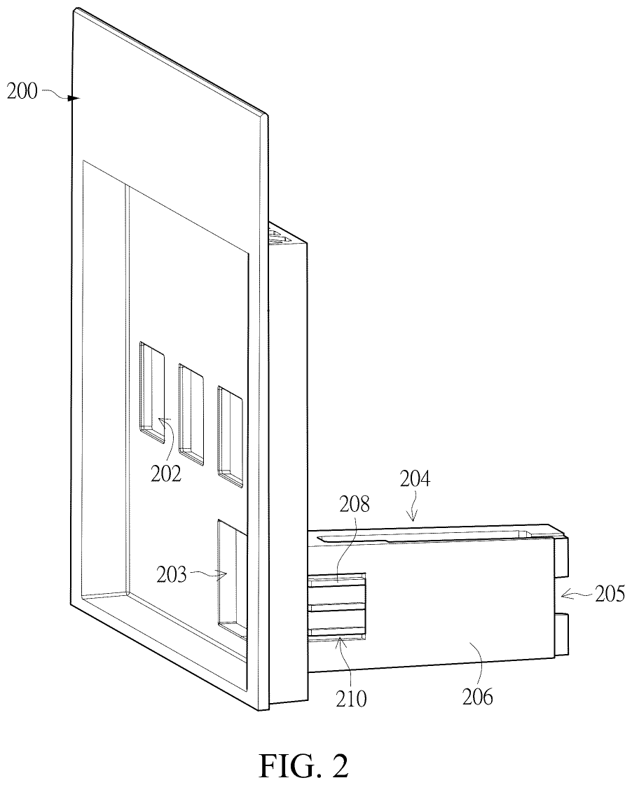

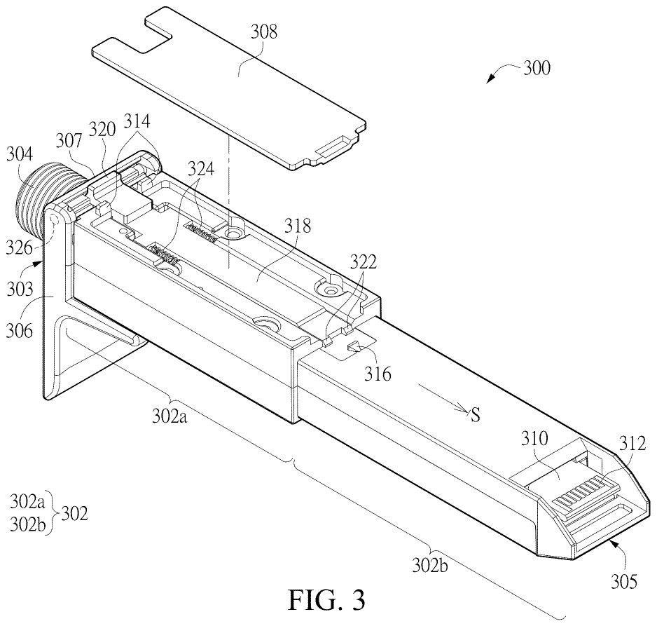

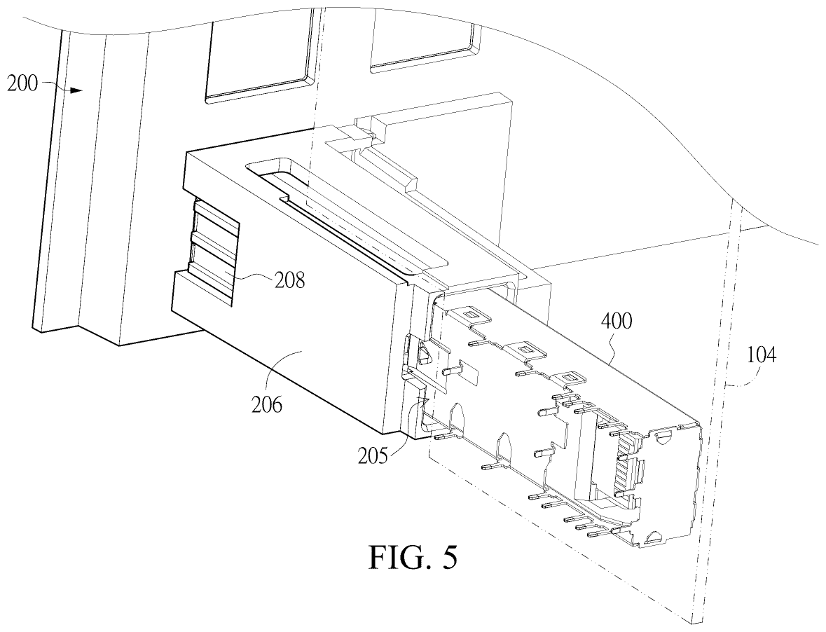

FIG. 2 shows the details of the panel 200 and the slot 204. As previously mentioned, the panel 200 may have a connector hole 202 and a slot 204. The slot 204 may have a front opening 203 and a rear opening 205, wherein the front opening 203 is formed in the panel 200, and the slot housing 206 may extend between the front opening 203 and the rear opening 205. The pluggable module 300 can pass through the slot 204 via the front opening 203 and rear opening 205. The slot 204 may also include a first hook 208 located within the slot 204. In some embodiments, the panel 200, slot housing 206, and first hook 208 are all made of plastic and are integrally formed. The slot housing 206 may have apertures 210 formed therein to accommodate the first hook 208. The wall of the slot housing 206 has a thickness that allows the first hook 208 to be attached thereon. The first hook 208 itself has a certain degree of flexibility; when the pluggable module 300 is inserted into the slot 204, the first hook 208 can latch onto the first locking protrusion 314 located on the front body 302a of the pluggable module 300 (see FIG. 3). In some embodiments, the size of the rear opening 205 of the slot 204 may be large enough to allow at least a portion of the pluggable module receiver 400 to pass through, such that at least a portion of the pluggable module receiver 400 is located within the slot 204 (see FIG. 5).

FIG. 3 shows the details of the pluggable module 300. The pluggable module 300 may include a body 302, wherein the body 302 further includes a front body 302a and a rear body 302b. The front body 302a includes a front end 303 of the body 302, and the rear body 302b includes a rear end 305 of the body 302. The connector 304 can be connected to the front end 303 and can be electrically connected to a circuit board 310 within the pluggable module 300 for signal transmission. An end of the circuit board 310 may have an edge connector 312 for docking with an adapter (not shown) in the pluggable module receiver 400, so as to transmit signals to the circuit board 104 in the electronic apparatus 100. The pluggable module 300 may also include a first locking protrusion 314, a second locking protrusion 316, and an unlocking plate 318 for locking and unlocking operations. The first locking protrusion 314 is located on the front body 302a, and the second locking protrusion 316 is located on the rear body 302b. The first locking protrusion 314 and the second locking protrusion 316 are configured to respectively latch with the electronic apparatus 100 after the pluggable module 300 is inserted into the electronic apparatus 100. The first locking protrusion 314 is configured to latch with the first hook 208 of the slot 204 (see FIG. 2), while the second locking protrusion 316 is configured to latch with the second hook 406 of the pluggable module receiver 400 (see FIG. 4). At least a portion of the unlocking plate 318 can be accommodated within the front body 302a and covered by the upper cover 308. The unlocking plate 318 can be configured to shift along the body 302, for example, to shift between the front end 303 and the rear end 305 of the pluggable module 300, and the direction of the shifting of the unlocking plate 318 can be influenced by a pull plate 306 and a spring 324. Specifically, the pull plate 306 is pivotally connected to the front body 302a via a pivot shaft 326. When the pull plate 306 pivots relative to the front body 302a, the pull plate end 307 of the pull plate 306 pushes against the unlocking plate 318, causing the unlocking plate 318 to shift in the direction S from the front end 303 to the rear end 305, thereby disengaging the latching between the first locking protrusion 314 and the first hook 208 of the slot 204 in the electronic apparatus 100, as well as disengaging the latching between the second locking protrusion 316 and the second hook 406 of the pluggable module receiver 400 in the electronic apparatus 100. In other words, the pluggable module 300 can lock with two different structures which are the slot 204 and the pluggable module receiver 400, and the same unlocking plate 318 can simultaneously release the locking between the pluggable module 300 and the slot 204, as well as the locking between the pluggable module 300 and the pluggable module receiver 400. The unlocking plate 318 may include a first unlocking portion 320 and a second unlocking portion 322, wherein the first unlocking portion 320 is configured to release the latching between the first locking protrusion 314 and the first hook 208 in the electronic apparatus 100, and the second unlocking portion 322 is configured to release the latching between the second locking protrusion 316 and the second hook 406 in the electronic apparatus 100. In order to allow the second unlocking portion 322 of the unlocking plate 318 to unlock the second locking protrusion 316, the length of the unlocking plate 318 may be longer than the front body 302a so as to extend onto the rear body 302b, and at least a portion of the unlocking plate 318 (especially the second unlocking portion 322) may be configured to shift on the outer surface of the rear body 302b. To accommodate the unlocking plate 318 within the front body 302a and allow the second unlocking portion 322 of the unlocking plate 318 to shift on the outer surface of the rear body 302b, the front body 302a may be thicker than the rear body 302b.

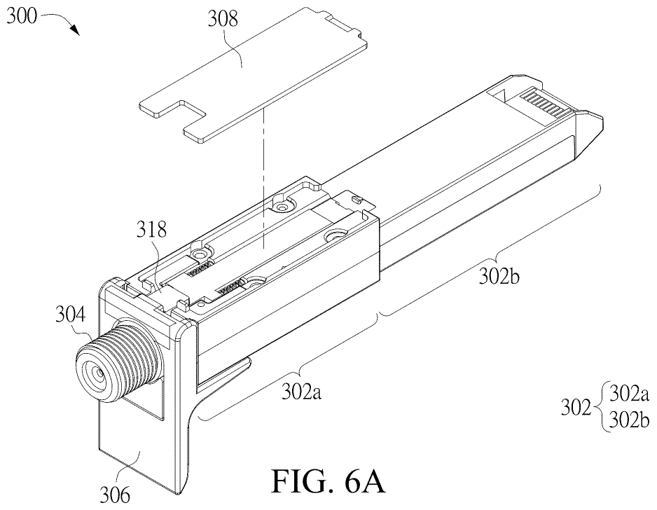

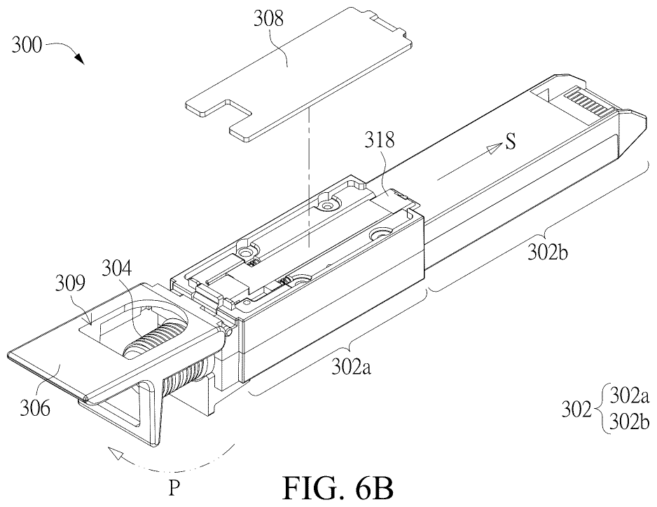

When the user sets the pull plate 306 to the default position shown in FIG. 3, the spring 324 can urge the unlocking plate 318 to shift in the direction from the rear end 305 to the front end 303 back to the default position. The details of the locking and unlocking mechanism between the pluggable module 300 and the electronic apparatus 100 will be described subsequently in FIG. 6A to FIG. 8B.

FIG. 4 shows the details of the pluggable module receiver 400. The pluggable module receiver 400 includes a receiver housing 402 and a second hook 406 attached to the receiver housing 402. The wall of the receiver housing 402 has a thickness that allows the second hook 406 to be attached thereto. The receiver housing 402 may have pins 404 used for securing the pluggable module receiver 400 to the circuit board 104 (refer to FIG. 1). The pluggable module receiver 400 has a receiving port 412. The pluggable module receiver 400 can be configured to receive the rear body 302b of the pluggable module 300 through its receiving port 412. The second hook 406 may have curved end portion 410 curving upwardly, making it easier for the second unlocking portion 322 of the unlocking plate 318 to conduct unlocking operation. The second hook 406 may have a locking aperture 408, wherein the shape of the locking aperture 408 can fit with the second locking protrusion 316 of the pluggable module 300. The second hook 406 itself has a certain degree of flexibility; when the rear body 302b of the pluggable module 300 is inserted into the pluggable module receiver 400, the second locking protrusion 316 of the pluggable module 300 can fall into the locking aperture 408 of the second hook 406, causing the second hook 406 to latch onto second locking protrusion 316. The receiver housing 402 and the second hook 406 can be made of plastic or metal, and the receiver housing 402 and the second hook 406 can be integrally formed or connected together by welding, adhesive, or other means.

FIG. 5 shows the alignment state between the slot 204 and the pluggable module receiver 400. As previously mentioned, the slot 204 and the pluggable module receiver 400 are separate components, so they must be aligned to allow the pluggable module 300 to be inserted into both the slot 204 and the pluggable module receiver 400 simultaneously. Since the pluggable module receiver 400 is fixed on the circuit board 104, the position of the circuit board 104 can be moved to align the pluggable module receiver 400 with the slot 204. The front opening 203 and rear opening 205 of the slot 204, and the receiving port 412 of the pluggable module receiver 400 can be aligned along the insertion direction I for the pluggable module 300 to be inserted. In some embodiments, the rear opening 205 of the slot 204 is large enough to allow at least a portion of the pluggable module receiver 400 to pass through, such that the receiving port 412 of the pluggable module receiver 400 is located between the front opening 203 and the rear opening 205 of the slot 204, making alignment easier. In some alternative embodiments, the pluggable module receiver 400 might not pass through the rear opening 205 of the slot 204.

FIG. 6A and FIG. 6B show a schematic view of the pull plate 306 of the pluggable module 300 pushing the unlocking plate 318 via pivoting. The pluggable module 300 is in a default state in FIG. 6A. The pull plate 306 may have a pull plate aperture 309 and is pivotally connected to the front body 302a (corresponding to FIG. 3). The user can pull the pull plate 306 in the pivoting direction P as shown in FIG. 6B, so that when the pull plate 306 pivots relative to the front body 302a, the pull plate end 307 of the pull plate 306 (see FIG. 3) pushes against the unlocking plate 318, allowing the unlocking plate 318 to shift in the shifting direction S. When the pull plate 306 pivots, the connector 304 can pass through the pull plate aperture 309 in the pull plate 306 to avoid obstructing the pivoting of the pull plate 306. The connector 304 in this embodiment is a coaxial connector, but it may also be another types of connectors.

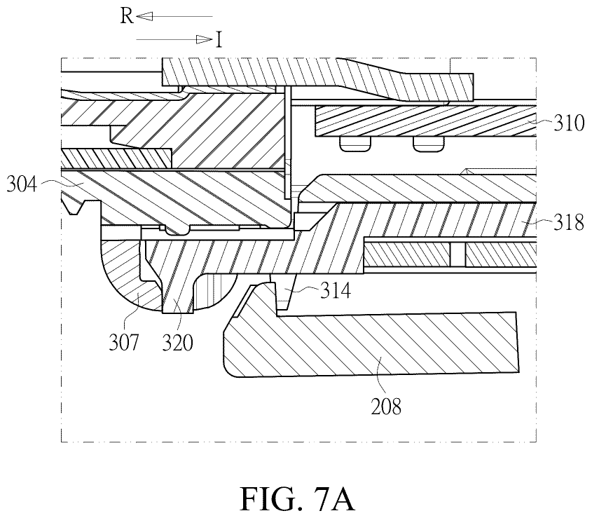

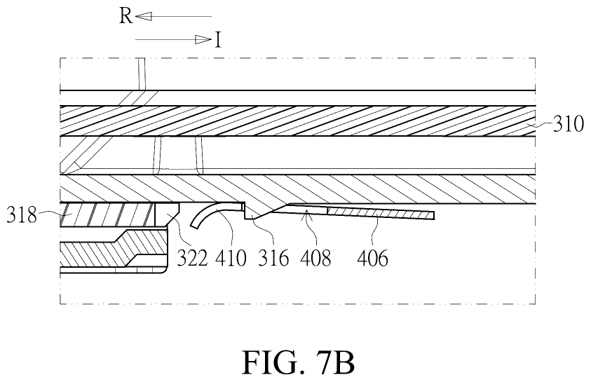

FIG. 7A and FIG. 7B show the details of the locking between the pluggable module 300 and the electronic apparatus 100, wherein FIG. 7A shows the state in which the first locking protrusion 314 located on the front body 302a is latched with the first hook 208 in the slot 204, and FIG. 7B shows the state in which the second locking protrusion 316 located on the rear body 302b is latched with the second hook 406 in the pluggable module receiver 400. As shown in FIG. 7A and FIG. 7B, a portion of the end of the first hook 208 is inclined along the insertion direction I, and the curved end portion 410 of the second hook 406 is also curved along the insertion direction I, making it easier for the pluggable module 300 to be inserted into the slot 204 and the pluggable module receiver 400. When the pluggable module 300 is inserted into the slot 204 and the pluggable module receiver 400, the first hook 208 latches onto the first locking protrusion 314, and the second hook 406 latches onto the second locking protrusion 316. At this point, since unlocking has not yet been performed, the unlocking plate 318 is in the default position.

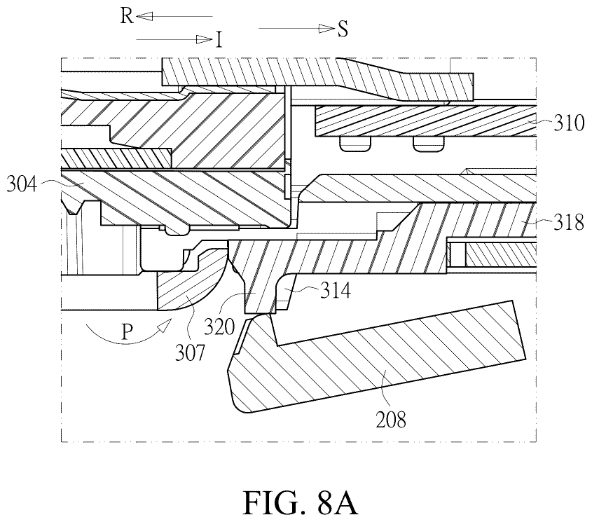

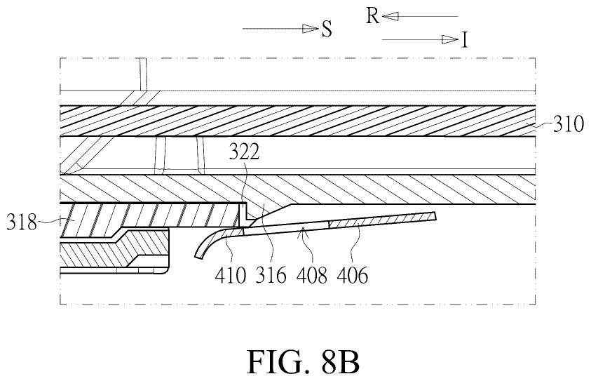

FIG. 8A and FIG. 8B show the details of the unlocking of the pluggable module 300 and the electronic apparatus 100, wherein FIG. 8A shows the state in which the first locking protrusion 314 located on the front body 302a is unlocked from the first hook 208 in the slot 204, and FIG. 8B shows the state in which the second locking protrusion 316 located on the rear body 302b can be unlocked from the second hook 406 in the pluggable module receiver 400. As previously mentioned, the pull plate 306 can pivot in the pivoting direction P to push the unlocking plate 318 via the pull plate end 307, while FIG. 8A more clearly shows how the pull plate end 307 pushes the unlocking plate 318 when pivoting in the pivoting direction P. The first unlocking portion 320 of the unlocking plate 318 is protruding, so when the unlocking plate 318 shifts in the shifting direction S, the first unlocking portion 320 can squeeze the first hook 208 out of the locked position shown in FIG. 7A, thereby achieving the unlocking shown in FIG. 8A. Furthermore, as shown in FIG. 8B, when the unlocking plate 318 shifts in the shifting direction S, the second unlocking portion 322 of the unlocking plate 318 can act like a shovel and reach beneath the curved end portion 410 of the second hook 406 to lift the second hook 406, thereby achieving unlocking. As shown in FIG. 8A and FIG. 8B, after the pluggable module 300 is inserted into the slot 204 and the pluggable module receiver 400, the shifting direction S of the unlocking plate 318 is the same as the insertion direction I of the pluggable module 300 being inserted into the electronic apparatus 100, and is opposite to the removal direction R.

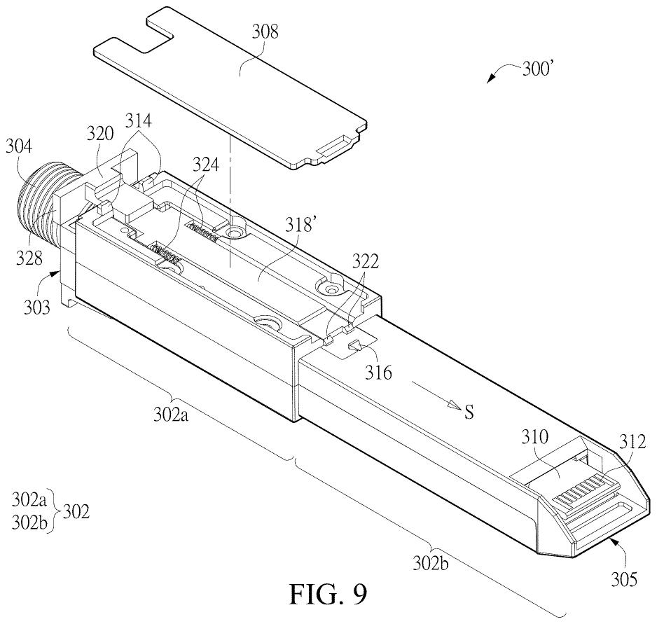

FIG. 9 shows a pluggable module 300′ that is a variation of the pluggable module 300 in FIG. 3. The main difference between FIG. 9 and FIG. 3 is that the design of the unlocking plate 318′ in FIG. 9 is different from the unlocking plate 318 in FIG. 3, and the pluggable module 300′ in FIG. 9 does not have the pull plate 306 found in FIG. 3. The pluggable module 300′ includes a force application plate 328 connected to the first unlocking portion 320. The user can apply force to the force application plate 328 to shift the unlocking plate 318′ in the shifting direction S to perform the unlocking operation. The remaining features of the pluggable module 300′ are the same as those of the pluggable module 300, and are not be repeated herein.

The foregoing embodiments were chosen and described in order to explain the techniques of the present disclosure and their practical applications. Alternative embodiments will be apparent to those skilled in the art without departing from the spirit and scope of the present disclosure.

What is claimed is:

1. An electronic apparatus capable of allowing a pluggable module to be inserted along an insertion direction, the electronic apparatus comprising:
a panel;
a slot having a front opening and a rear opening, the front opening being formed in the panel, the slot comprising:
a slot housing and a first hook attached to the slot housing, the slot housing extending between the front opening and the rear opening; and
a pluggable module receiver having a receiving port, the pluggable module receiver being disposed within the electronic apparatus, and the pluggable module receiver comprising:
a receiver housing and a second hook attached to the receiver housing;
wherein:
the front opening, the rear opening, and the receiving port are aligned along the insertion direction for allowing the pluggable module to be inserted; and
the first hook and the second hook are configured to respectively latch onto the pluggable module after the pluggable module is inserted into the electronic apparatus.

2. The electronic apparatus according to claim 1, wherein the pluggable module receiver is configured to pass through the rear opening of the slot, such that the receiving port of the pluggable module receiver is located between the front opening and the rear opening of the slot.

3. A pluggable module capable of being inserted into an electronic apparatus, the pluggable module comprising:
a body, comprising:
a front body comprising a front end of the body; and
a rear body comprising a rear end of the body;
a first locking protrusion located on the front body;
a second locking protrusion located on the rear body; and
an unlocking plate, at least a portion of the unlocking plate being accommodated within the front body;
wherein:
the first locking protrusion and the second locking protrusion are configured to respectively latch with the electronic apparatus after the pluggable module is inserted into the electronic apparatus; and
the unlocking plate is configured to shift in a shifting direction from the front end to the rear end to release the latching between the first locking protrusion and the electronic apparatus as well as the latching between the second locking protrusion and the electronic apparatus.

4. The pluggable module according to claim 3, wherein the front body is thicker than the rear body.

5. The pluggable module according to claim 3, wherein the unlocking plate comprises a first unlocking portion and a second unlocking portion, the first unlocking portion configured to release the latching between the first locking protrusion and the electronic apparatus, and the second unlocking portion configured to release the latching between the second locking protrusion and the electronic apparatus.

6. The pluggable module according to claim 5, wherein the second unlocking portion is configured to shift on an outer surface of the rear body.

7. The pluggable module according to claim 3, further comprising a connector connected to the front end.

8. The pluggable module according to claim 7, wherein the connector is a coaxial connector.

9. The pluggable module according to claim 3, further comprising a pull plate pivotally connected to the front body.

10. The pluggable module according to claim 9, wherein the pull plate is configured to push the unlocking plate by pivoting relative to the front body, causing the unlocking plate to shift in the direction from the front end to the rear end.

11. An electronic apparatus comprising:
a slot comprising:
a first hook located within the slot;
a pluggable module receiver comprising:
a second hook located within the pluggable module receiver; and
a pluggable module comprising:
a body, comprising:
a front body comprising a front end of the body; and
a rear body comprising a rear end of the body;
a first locking protrusion located on the front body; and
a second locking protrusion located on the rear body;
wherein:
the pluggable module is configured to pass through the slot and be inserted into the pluggable module receiver along an insertion direction;
the first locking protrusion of the pluggable module is configured to latch with the first hook of the slot; and
the second locking protrusion of the pluggable module is configured to latch with the second hook of the pluggable module receiver.

12. The electronic apparatus according to claim 11, further comprising an unlocking plate configured to shift along the body, and at least a portion of the unlocking plate being accommodated within the front body.

13. The electronic apparatus according to claim 12, wherein:
the unlocking plate is configured to shift in a shifting direction from the front end to the rear end to release the latching between the first locking protrusion and the first hook as well as the latching between the second locking protrusion and the second hook.

14. The electronic apparatus according to claim 13, further comprising a pull plate pivotally connected to the front body, wherein the pull plate is configured to push the unlocking plate by pivoting relative to the front body, causing the unlocking plate to shift in the direction from the front end to the rear end.

15. The electronic apparatus according to claim 13, wherein, when the pluggable module is inserted into the pluggable module receiver, the shifting direction is the same as the insertion direction.

16. The electronic apparatus according to claim 11, wherein at least a portion of the pluggable module receiver is located within the slot.

17. The electronic apparatus according to claim 12, wherein the front body is thicker than the rear body, and at least a portion of the unlocking plate is configured to shift on an outer surface of the rear body.

18. The electronic apparatus according to claim 11, further comprising a coaxial connector connected to the front end.

19. The electronic apparatus according to claim 18, further comprising a pull plate having a pull plate aperture and pivotally connected to the front body, the pull plate being configured to allow the coaxial connector to pass through the pull plate aperture when pivoting relative to the front body.

20. The electronic apparatus according to claim 11, further comprising a circuit board disposed within the electronic apparatus, the pluggable module receiver being fixed to the circuit board, wherein:
a position of the circuit board within the electronic apparatus is arranged such that the pluggable module receiver is aligned with the slot along the insertion direction.
